(19) United States
(12) Patent Application Publication
(10) Pub. No.: US 2006/0207654 A1
(43) Pub. Date: Sep. 21, 2006

(54) Proportional pressure adjusting valve with two main valves and two diaphragms

(76) Inventor: Chun-Cheng Huang, Taipei (TW)

Correspondence Address: BACON & THOMAS, PLLC, 625 SLATERS LANE, FOURTH FLOOR, ALEXANDRIA, VA, 22314, US

(21) Appl. No.: 11/082,847

(22) Filed: Mar. 18, 2005

(51) Int. Cl. G05D 7/06

(52) U.S. Cl. 137/66

(57) ABSTRACT

A proportional pressure adjusting valve with two main valves and two diaphragms, of which the two diaphragms of different sizes are lapped one over the other to act on each other and to control a second main valve, the smaller diaphragm and the second main valve connected with it are used to sense the change of pressure at a gas outlet to automatically adjust the size of a gas inlet; the amount of gas received by an aeration chamber of the larger diaphragm controls the force of a spring being compressed between the larger and the smaller diaphragms, so that a flow able to proportionally and automatically adjust can be obtained to firstly kindle up a mother fire, then to make kindling of a main fire, thereby to delay shutting of the mother fire.

### BACKGROUND OF THE INVENTION

1. Field of the Invention

The present invention is related to a proportional pressure adjusting valve with two main valves and two diaphragms used in supplying technique of combustion gas provided by a gas combusting appliance, wherein a first main valve has a function to firstly kindle up a mother fire, then to make kindling of a main fire, thereby to delay shutting of the mother fire; while a second main valve has a function to sensing the change of pressure of the combustion gas and to stabilize the pressure at the outlet, as well as to proportionally control the flow of the outlet of the combustion gas taking advantage of the mutual action between a larger and a smaller diaphragm; the structure can be used on any proportional adjusting valve having two diaphragms with different kinds and pressures of combustion gas.

2. Description of the Prior Art

Normally, combustion gas is controlled at the standard of safety required; it needs two main valves at an outlet to guarantee that: in case one of the main valves leaks because of being abnormal of the outlet, the second main valve can form separation to prevent this. However, provision of the two main valves generally is substituted by mechanical water valves, or a first main valve directly driven in an electromagnetic way is applied in stead; the former costs more, and the water leaking problem is continuously created by water pressure, the latter needs larger electric power to result an electricity exhaustion phenomenon; if these two modes coexist, when they are activated, a mother fire is kindled up to make kindling of a main fire, the mother fire will keep on combusting, this results unnecessary combusting exhaustion; and lapping of the mother fire with the main fire creates a phenomenon of incomplete combustion.

Moreover, the second main valve generally is used for preventing leakage, if this main valve can be used to proportionally control flow to stabilize the pressure of the valve in addition to being used for preventing leakage, its function can be multiplied. However, valves for adjusting flow in the market presently are primarily for adjusting sizes of bores; by using such an adjusting mode, when intake pressure is changed, a shortage is created accordingly in that outlet pressure becomes unstable, and when the flow adjusting is performed by bore adjusting, if the kind of combustion gas is changed, another shortage is created in that the entire valve must be changed.

### SUMMARY OF THE INVENTION

In view of the above stated, the proportional pressure adjusting valve with two main valves and two diaphragm of the present invention is developed after elaborate study against the above conventional valves to have two main valves to prevent leakage probably induced in the case that the only one main valve provided leaks; and the first one of the main valves is provided with a delay mother-fire valve able to delay extinguishing of the mother fire for reducing waste of combustion gas.

The adjusting valve mainly is comprised of a first main valve having a single diaphragm and a second main valve having two diaphragms. Wherein the diaphragm of the first main valve forms a first main valve plug in a normal pressure chamber, the first main valve plug seals the first main valve by means of a main spring provided in a back pressure chamber of the diaphragm; and the first main valve has a two-way micro electromagnetic valve to control whether gas enters the back pressure chamber with a normally opened hole, the two-way micro electromagnetic valve has a normally closed hole to connect a mother fire combustor and a delay mother-fire valve outlet provided at the side of the outlet of the first main valve to be press held by the first main valve plug, an intake hole of the delay mother-fire valve is communicated with the side of the outlet of the first main valve, a top rod is used to press hold the first main valve. When the first main valve is closed, the delay mother-fire valve is opened; on the contrary, when the first main valve is opened to a predetermined extent, it closes the delay mother-fire valve.

The second main valve is designed to be a proportional pressure adjusting valve having two diaphragms, it has a second main valve plug that seals the outlet communicating with a main combustor, a valve stem is provided to connect the second main valve plug with a smaller diaphragm, a pressure adjusting chamber is formed between the second main valve plug and the smaller diaphragm, at one side of the smaller diaphragm there is an atmosphere pressure chamber provided therein with a pressure adjusting spring of which one end holds the smaller diaphragm; the other end of the pressure adjusting spring can be pulled to stretch and press held by a larger diaphragm, the larger diaphragm is in turn pushed away by a larger spring. One end of the larger spring is fixedly provided on a housing at one side of the atmosphere pressure chamber; by separation of the larger diaphragm, an aeration chamber is formed, the gas intake side of the aeration chamber receives gas of which the amount is controlled by a normally closed micro electromagnetic valve, the gas discharge side of the aeration chamber discharges gas of which the amount is controlled by a normally opened micro electromagnetic valve; thereby, when the normally closed micro electromagnetic valve is turned on to open and combustion gas enters the aeration chamber, the larger diaphragm will be compressed, in turn the larger diaphragm will compress the larger spring, meantime, the pressure adjusting spring will be changed from its stretching state (namely, the state of closing the second main valve plug) to the state of compressing of the pressure adjusting spring, thereby the second main valve plug is opened; at this time, if the pressure of the combustion gas changes, it will automatically drive the smaller diaphragm to provide an adjusting action to close or open the second main valve plug to an extent, thereby a function of stabilizing the pressure and flow of supplying of the combustion gas is obtained.

And more, the larger diaphragm can be further provided thereon with a permanent magnet, and with a distance-adjustable induced magnetism detector at a position in opposition to that of the permanent magnet in order to timely make control whether a normally opened micro electromagnetic valve at the discharging side is to activate or turn off.

Thereby, to provide a valve structure able to sense change of combustion gas to stabilize the outlet pressure of the combustion gas and to proportionally control the outlet flow of the valve, the same valve structure can be applied to proportional pressure adjusting valve structures (each with two diaphragms) using different combustion gas and having multiplication effects.

The present invention will be apparent in its structure as well as its mode of operation after reading the detailed description of the preferred embodiment thereof in reference to the accompanying drawings.

### BRIEF DESCRIPTION OF THE DRAWINGS

FIG. 1 is a sectional view showing the structure of the present invention;

FIG. 2 is a sectional schematic view showing the state of operation of a two-way micro electromagnetic valve of the present invention;

FIG. 3 is a sectional schematic view showing the state of operation of a normally closed micro electromagnetic valve of the present invention;

FIG. 4 a sectional schematic view showing the state of operation of a normally opened micro electromagnetic valve of the present invention;

FIG. 5 is a sectional schematic view showing the state of completely opening operation of a second main valve plug of the present invention;

FIG. 6 an enlarged sectional schematic view showing a permanent magnet and a distance-adjustable induced magnetism detector of the present invention;

FIG. 7 is a sectional view showing another embodiment of the present invention.

### DETAILED DESCRIPTION OF THE PREFERRED EMBODIMENT

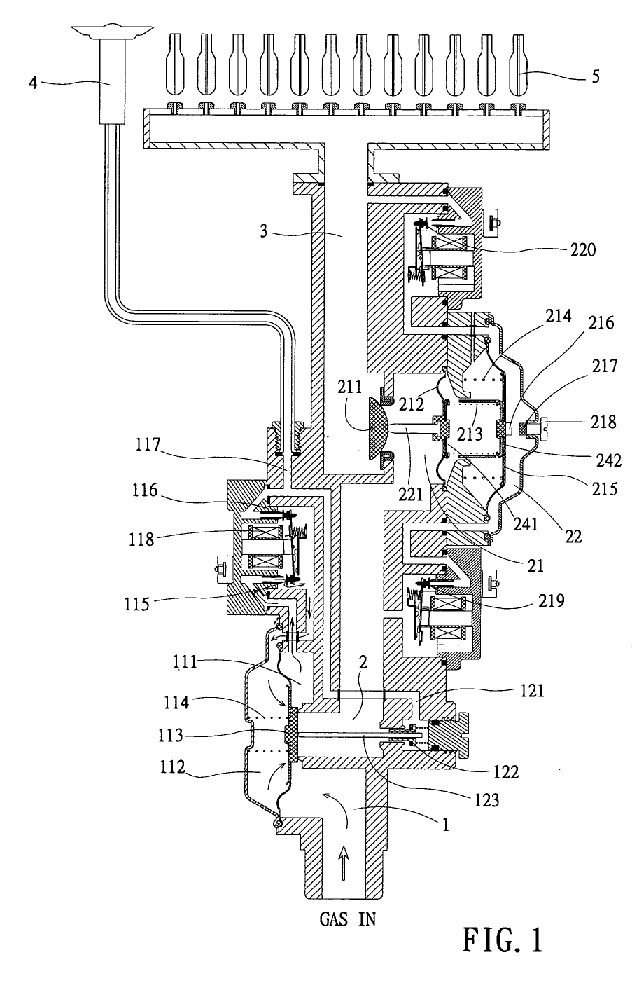

The proportional pressure adjusting valve with two main valves and two diaphragms of the present invention is structurally comprised basically of, as shown in FIG. 1, a first main valve having a single diaphragm at a main gas inlet 1 of combustion gas, and a second main valve having two diaphragms at the front section of an outlet 3 of combustion gas.

The diaphragm of the first main valve forms a first main valve plug 113 in a normal pressure chamber 111, the first main valve plug 113 normally seals the first main valve by means of a main spring 114 provided in a back pressure chamber 112 of the diaphragm; and the first main valve has a two-way micro electromagnetic valve 118 to control whether gas enters the back pressure chamber 112 with a normally opened hole 115, the two-way micro electromagnetic valve 118 has a normally closed hole 116 to connect a mother fire combustor 4 and a delay mother-fire valve outlet 121 provided at the side of the outlet 2 of the first main valve to be press held by the first main valve plug 113, the delay mother-fire valve outlet 121 is controlled by a delay mother-fire valve 122 press held by the first main valve plug 113, an intake hole of the delay mother-fire valve 122 is communicated with the side of the outlet 2 of the first main valve, a top rod 123 is used to press hold the first main valve 113. When the first main valve plug 113 is closed, the delay mother-fire valve 122 is normally opened; on the contrary, when the first main valve is opened to a predetermined extent, it closes the delay mother-fire valve 122.

The second main valve has a second main valve plug 211 that seals the outlet 3 communicating with a main combustor, a valve stem is provided to connect the second main valve plug 211 with a smaller diaphragm 212, a pressure adjusting chamber 21 is formed between the second main valve plug 211 and the smaller diaphragm 212, at one side of the smaller diaphragm 212 there is an atmosphere pressure chamber provided therein with a pressure adjusting spring 213 of which one end holds the smaller diaphragm 212; the pressure adjusting spring 213 is provided between a smaller diaphragm seat 241 and a larger diaphragm seat 242, in order that its one end can be stretched and press held by a larger diaphragm 215; the larger diaphragm 215 is in turn pushed away by a larger spring 214. One end of the larger spring 214 is fixedly provided on a housing at one side of the atmosphere pressure chamber; by separation of the larger diaphragm 215, an aeration chamber 22 is formed, the gas intake side of the aeration chamber 22 receives gas of which the amount is controlled by a normally closed micro electromagnetic valve 219, the gas discharge side of the aeration chamber 22 discharges gas of which the amount is controlled by a normally opened micro electromagnetic valve 220; thereby, when the normally closed micro electromagnetic valve 219 is turned on to open and combustion gas enters the aeration chamber 22, the larger diaphragm 215 will be compressed, in turn the larger diaphragm 215 will compress the larger spring 214, meantime, the pressure adjusting spring 213 will be changed from its stretching state (namely, the state of closing the second main valve plug 211) to the state of compressing of the pressure adjusting spring 213, thereby the second main valve plug 211 is opened; at this time, if the pressure of the combustion gas changes, it will automatically drive the smaller diaphragm 212 to provide an adjusting action to close or open the second main valve plug 211 to an extent, thereby a function of stabilizing the pressure and flow of supplying of the combustion gas is obtained.

Thereby, to provide a valve structure able to sense change of combustion gas to stabilize the outlet pressure of the combustion gas and to proportionally control the outlet flow of the valve, the same valve structure can be applied to proportional pressure adjusting valve structures (each with two diaphragms) using different combustion gas and having multiplication effects.

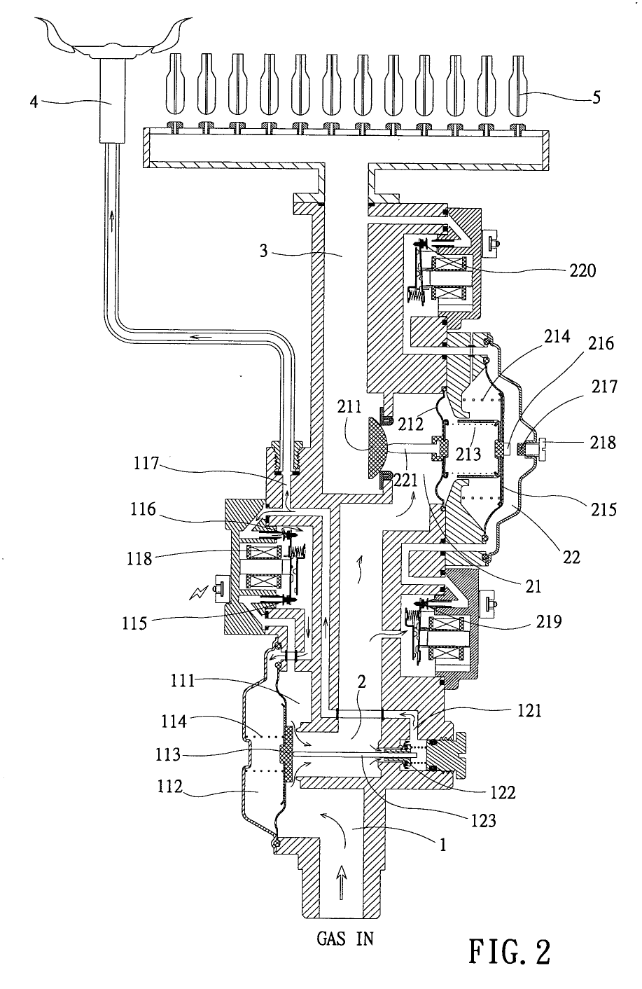

As shown in FIG. 2, when a combusting appliance receives a starting signal, the two-way micro electromagnetic valve 118 of it receives a voltage to close the normally opened hole 115, meantime to open the normally opened hole 116, at this time, the combustion gas flowing to the back pressure chamber 112 from the normal pressure chamber 111 is blocked, thereby the combustion gas in the back pressure chamber 112 leaks out toward a connecting passageway 117 and the mother fire combustor 4 by opening of the normally opened hole 116; now the first main valve plug 113 is opened by pressure reducing of the back pressure chamber 112, thus the combustion gas flows to the second main valve through the side of the outlet 2 of the first main valve, and by virtue that the delay mother-fire valve 122 is still open, the combustion gas further flows to the connecting passageway 117 through the delay mother-fire valve outlet 121, and enters the back pressure chamber 112 through the normally opened hole 116, in order that the diaphragm and the first main valve plug 113 tend to seal the valve; however, the mother fire combustor 4 still consumes combustion gas, hence the first main valve plug 113 is in a slightly opening state, so that the mother fire combustor 4 keeps being supplied with combustion gas for the mother fire in a nonstop state (the combustion gas for the mother fire is not stopped until the second main valve plug 211 is opened). Meantime, although the combustion gas is also supplied for the normally closed micro electromagnetic valve 219 of the second main valve; but by virtue that the normally closed micro electromagnetic valve 219 has not yet been turned on to open, thus the combustion gas is blocked here, a main combustor 5 is still not in operation.

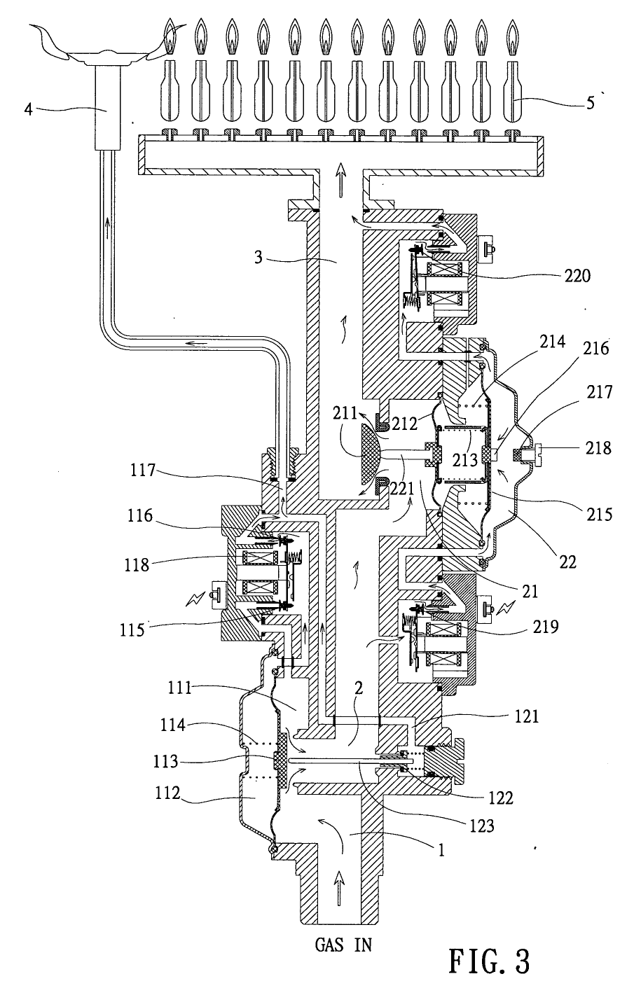

As shown in FIG. 3, when the normally closed micro electromagnetic valve 219 gets a voltage to open, combustion gas enters the aeration chamber 22 of the larger diaphragm 215, and then flows to the normally opened micro electromagnetic valve 220 at the gas discharge side to leak out to the outlet 3 of combustion gas for supplying the combustion gas required for operation of the main combustor 5. If the combustion gas entering the aeration chamber 22 of the larger diaphragm 215 is more than that leaking out to the normally opened micro electromagnetic valve 220, the pressure that the aeration chamber 22 obtains moves the larger diaphragm 215 leftwards to compress the larger spring 214, thus the smaller diaphragm 212 opens the second main valve plug 211 to a predetermined extent; if the normally closed micro electromagnetic valve 219 is opened and then closed, and the normally opened micro electromagnetic valve 220 keeps its close state, the second main valve plug 211 can stop at any predetermined position to maintain a constant flow to the side of the outlet of the combustion gas.

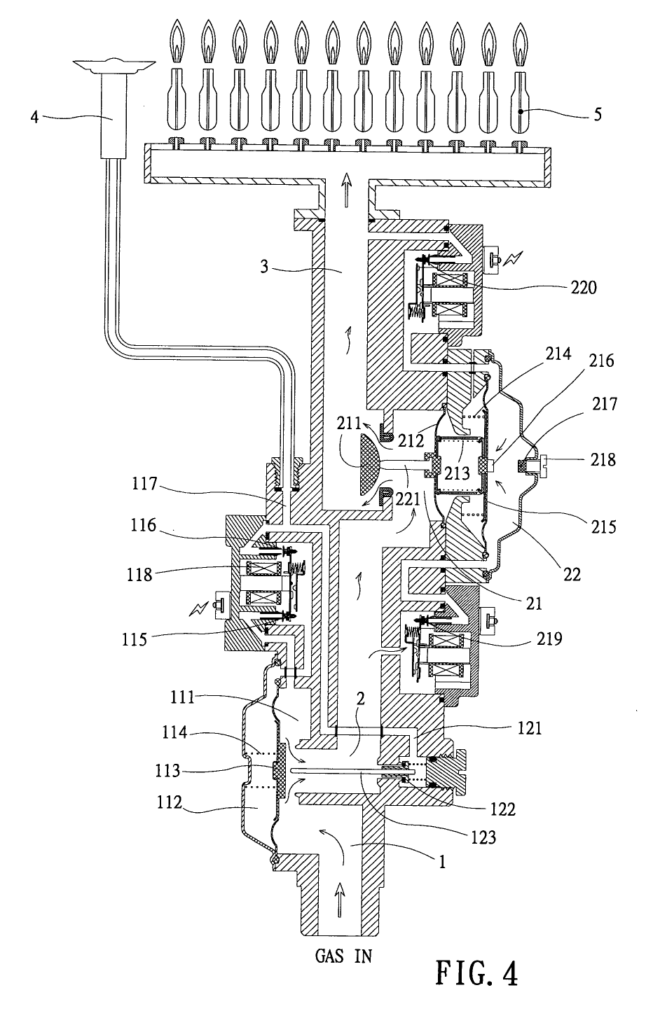

Moreover, if intake pressure is changed, the smaller diaphragm 212 will sense this change of pressure, and the pressure adjusting spring 213 reacts to automatically adjust the size of the outlet of the second main valve plug 211; that is, when the pressure is changed, as is shown in FIG. 4, the second main valve plug 211 will automatically be closed to an extent (because the smaller diaphragm 212 will be extruded to the right); on the contrary, when the pressure becomes smaller, the second main valve plug 211 will automatically be opened to an extent (because the smaller diaphragm 212 will be moved to the right by the action of the spring force), thereby an effect of stabilizing the flow of the outlet can be obtained.

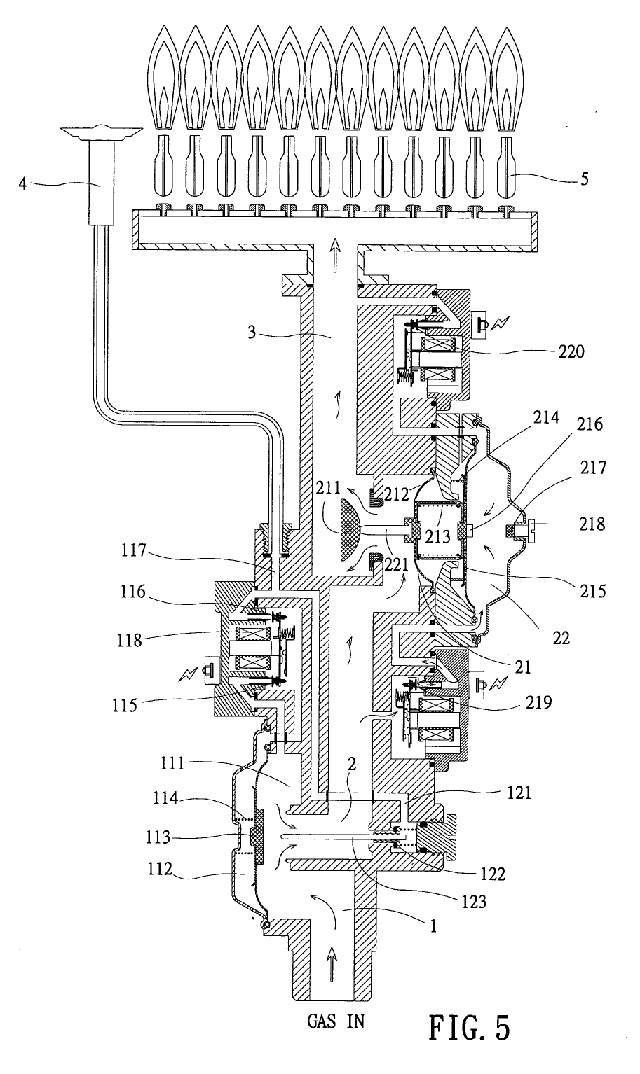

If it is desired to render the combustion gas appliance to get the maximum supplying flow of the combustion gas, such as is shown in FIG. 5, the normally closed micro electromagnetic valve 219 is opened all the way, and the normally opened micro electromagnetic valve 220 is closed all the way, the aeration chamber 22 now gets the maximum pressure, the larger diaphragm 215 thus is moved to the most left end to render the pressure adjusting spring 213 to be compressed to the endmost, and the second main valve plug 211 is opened to the maximum extent to get the maximum fire.

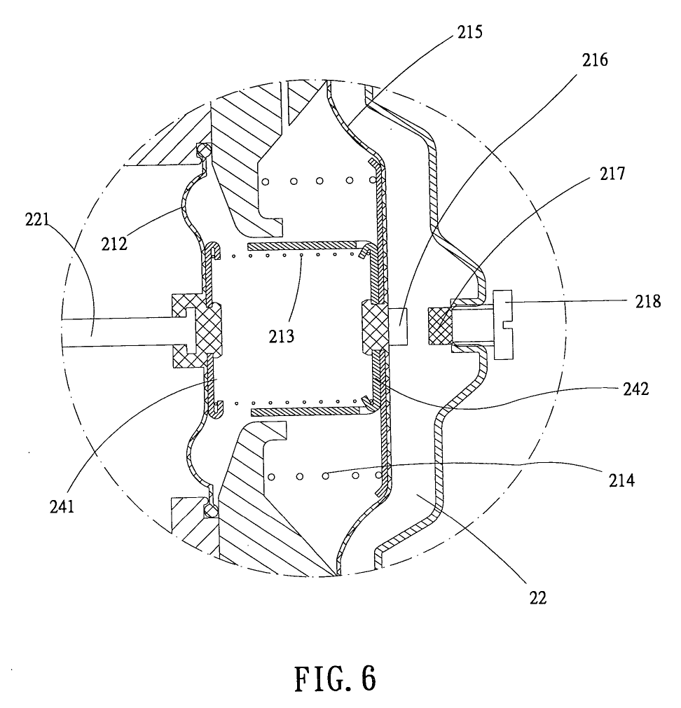

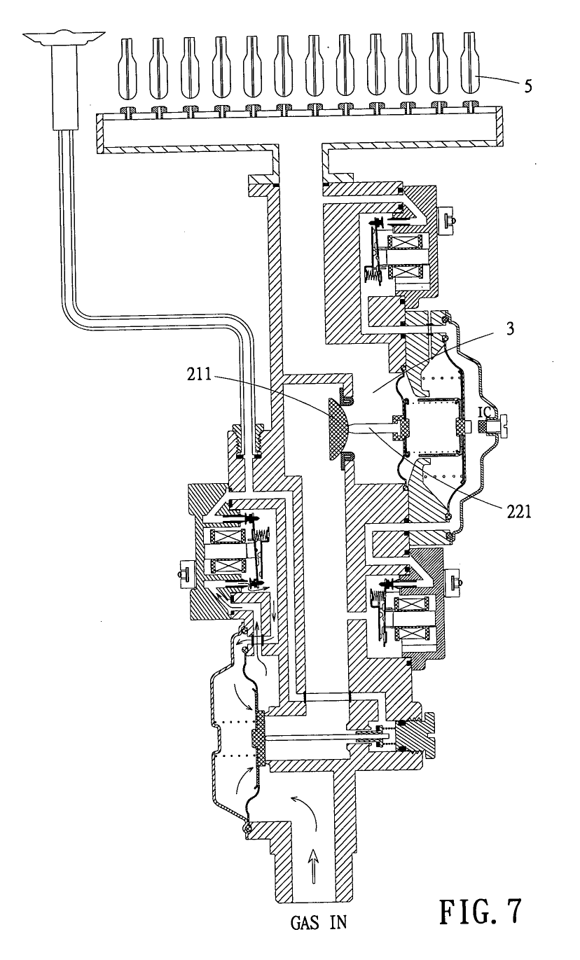

Please simultaneously refer to FIGS. 1 and 6, the present invention further is provided on the larger diaphragm seat 242 of the larger diaphragm 215 with a permanent magnet 216, and a distance-adjustable induced magnetism detector 217 is provided at a position in opposition to that of the permanent magnet 216, the distance-adjustable induced magnetism detector 217 can be composed of a Howard IC, its position of allocation is controlled by an adjusting screw 218, so that the state of displacement of the larger diaphragm 215 can be sensed by the distance-adjustable induced magnetism detector 217, in order to timely decide whether control of turning on/off of the normally opened micro electromagnetic valve 220 at the gas discharge side shall be executed. In the aforesaid embodiment, the present invention makes the valve itself allow the outlet 3 of the main combustor 5 for entering of combustion gas to be allocated at a side in opposition to a valve stem 221 relative to the second main valve plug 211; certainly, when in practicing, it can also be as shown in FIG. 7, to allow the outlet 3 of the main combustor 5 for entering of combustion gas to be allocated at a side same as that of the valve stem 221 relative to the second main valve plug 211, and the above stated function of stabilizing the pressure and flow of supplying of the combustion gas can be obtained by both these cases.

In conclusion, the present invention provides a preferred practicable structure of a proportional pressure adjusting valve with two main valves and two diaphragms for a gas combusting appliance; while the preferred embodiment shown and described is only for illustrating the present invention, and not for giving any limitation to the scope of the present invention; it will be apparent to those skilled in this art that various modifications or changes without departing from the spirit of this invention shall also fall within the scope of the appended claims.

Having thus described the technical process of my invention, what I claim as new and desire to be secured by Letters Patent of the United States is:

1. A proportional pressure adjusting valve with two main valves and two diaphragms, said adjusting valve comprises a first main valve and a second main valve, and is characterized in that: said second main valve has a proportional pressure adjusting valve having two diaphragms, and has a second main valve plug that seals a combustion gas outlet used for communicating with a main combustor, a valve stem is provided to connect said second main valve plug with a smaller diaphragm, a pressure adjusting chamber is formed between said second main valve plug and said smaller diaphragm, at one side of said smaller diaphragm there is an atmosphere pressure chamber provided therein with a pressure adjusting spring of which one end holds said smaller diaphragm; the other end of said pressure adjusting spring is adapted to being pulled to stretch and being press held by a larger diaphragm, said larger diaphragm is in turn pushed away by a larger spring; one end of said larger spring is fixedly provided on a housing at one side of said atmosphere pressure chamber; said larger diaphragm forms on one side thereof an aeration chamber, a gas intake side of said aeration chamber receives gas of which the amount is controlled by a normally closed micro electromagnetic valve, a gas discharge side of said aeration chamber discharges gas of which the amount is controlled by a normally opened micro electromagnetic valve.

2. The proportional pressure adjusting valve with two main valves and two diaphragms as in claim 1, wherein said larger diaphragm is provided thereon with a permanent magnet, and with a distance-adjustable induced magnetism detector at a position in opposition to that of said permanent magnet in order to detect the state of displacement of said larger diaphragm.

3. The proportional pressure adjusting valve with two main valves and two diaphragms as in claim 1, wherein said first main valve has a diaphragm forming a first main valve plug in a normal pressure chamber, said first main valve plug seals said first main valve by means of a main spring provided in a back pressure chamber of said diaphragm; and said first main valve has a two-way micro electromagnetic valve to control whether gas enters said back pressure chamber with a normally opened hole, said two-way micro electromagnetic valve has a normally closed hole to connect a mother fire combustor and a delay mother-fire valve outlet provided at a side of an outlet of said first main valve to be press held by said first main valve plug, said delay mother-fire valve outlet is controlled by a delay mother-fire valve press held by said first main valve plug, an intake hole of said delay mother-fire valve is communicated with said side of said outlet of said first main valve, a top rod is used to press hold said first main valve; when said first main valve is closed, said delay mother-fire valve is opened; on the contrary, when said first main valve is opened to a predetermined extent, it closes said delay mother-fire valve.
